(19) United States
(12) Patent Application Publication
(10) Pub. No.: US 2011/0148008 A1
(43) Pub. Date: Jun. 23, 2011

(54) MICRO-NANO IMPRINT MOULD AND IMPRINTING PROCESS

(75) Inventors: Yoou-Bin GUO, TAINAN CITY (TW); Yu-Chih KAO, TAINAN CITY (TW); Chau-Nan HONG, TAINAN CITY (TW)

(73) Assignee: NATIONAL CHENG KUNG UNIVERSITY, TAINAN CITY (TW)

(21) Appl. No.: 12/646,339

(22) Filed: Dec. 23, 2009

(51) Int. Cl. H05H 1/24; B29C 35/08; B29C 59/02; B28B 11/08

(52) U.S. Cl. 264/483; 264/494; 264/293; 425/385; 977/902

(57) ABSTRACT

A micro-nano imprint mould and an imprinting process are described. The micro-nano imprint mould includes: a porous body including a first surface and a second surface on opposite sides, wherein the porous body includes a plurality of holes, and a fluid can flow between the first surface and the second surface through the holes; and an imprint pattern structure set in the first surface of the porous body, wherein the imprint pattern structure includes a plurality of convexes and a plurality of concaves between the convexes.

### FIELD OF THE INVENTION

The present invention relates to an imprint mould, and more particularly to a micro-nano imprint mould and an imprinting process by applying the micro-nano imprint mould.

### BACKGROUND OF THE INVENTION

In current micro-nano imprint techniques, a solid hard material including no hole or a solid soft material is used, wherein the solid hard material is silicon and quartz, and the solid soft material is PDMS and plastics, foe example. When the hard material is used to form an imprint mould, concaves of a pattern structure are usually occupied by air, so that a resist does not easily flow into the concaves to block the concaves from be completely filled with the resist, thereby reducing the accuracy of the transferred pattern. In order to improve the problem, which the concaves of the pattern structure are not easily filled up, a method of performing an imprinting process under vacuum is typically adopted to increase the fill degree of the resist. However, the practicability of the method is low, thereby being unfavorable to mass production.

In addition, in the removal process of the mould composed the hard material, when the mould and the hard substrate are separated, the mould, the substrate or the pattern structure composed of the resist is damaged easily due to the vacuum state between the mould and the substrate, so that the yield of the pattern transferring is worse. In order to solve the problem occurred when the hard mould id removed, a technique is developed, in which a soft balloon is firstly disposed between the imprint mould and the resist, while the mould is removed, the balloon is filled with gas to prop the gap between the imprint mould and the resist up to let the air flow into the gap, so as to separate the imprint mould and the resist. However, such method still easily damages the brittle imprint mould or substrate, such as silicon or quartz.

In addition, although the imprint mould composed of the soft material is easily separated, air bubbles formed between the mould and the resist. Therefore, a problem, which the pattern structure of the mould cannot be completely filled with the resist, is also caused. Furthermore, the volume of the resist shrinks due to the evaporation of the solvent in the resist under the hard mould or the soft is adopted, the reversal imprint method is adopted or the resist contains the solvent in imprinting. Accordingly, the line width of the pattern structure composed of the resist is distorted, thereby greatly reducing the accuracy of the pattern transferring.

### SUMMARY OF THE INVENTION

Therefore, one aspect of the present invention is to provide a micro-nano imprint mould, in which its porous body is gas permeable, so that the fluidness of an imprint resist in imprinting is enhanced. Furthermore, the solvent in a resist solution, the solvent vapor and the air between the resist and the imprint mould can be drawn out through holes of the mould by vacuum air extracting during imprinting, so that the resist can completely fill up a pattern structure of the mould. Therefore, the imprint pattern of the mould can be accurately transferred to increase the accuracy and the yield of the imprinted pattern.

Another aspect of the present invention is to provide an imprinting process, in which an imprint mould is composed of a porous material, so that a high-pressure fluid can be infused from a rear surface of the imprint mould to make the solidified resist layer be easily separated from the imprint mould. Therefore, the accuracy and the yield of the imprinting process can be enhanced, and the imprint speed can be increased.

Still another aspect of the present invention is to provide an imprinting process, in which a solvent of an imprint resist and the evaporation thereof can penetrate a porous mould body through holes of the porous mould body, so that the shrink problem of the volume of the resist resulting from the evaporation of the solvent of the resist can be prevented to increase the faithfulness of the transfer of the pattern.

According to the aforementioned aspects, the present invention provides a micro-nano imprint mould. The micro-nano imprint mould includes a porous body and an imprint pattern structure. The porous body includes a first surface and a second surface on opposite sides, wherein the porous body includes a plurality of holes, and a fluid can flow between the first surface and the second surface through the holes. The imprint pattern structure is set in the first surface of the porous body, wherein the imprint pattern structure includes a plurality of convexes and a plurality of concaves between the convexes.

According to a preferred embodiment of the present invention, diameters of the holes are substantially the same, and a distribution density of the holes in the porous body is uniform.

According to another preferred embodiment of the present invention, a distribution density of the holes in the porous body is gradually changing from the first surface toward the second surface.

According to still another preferred embodiment of the present invention, diameters of the holes are gradually increasing from the first surface toward the second surface.

According to the aforementioned aspects, the present invention provides an imprinting process including the following steps. A micro-nano imprint mould is provided. The micro-nano imprint mould includes a porous body and an imprint pattern structure. The porous body includes a first surface and a second surface on opposite sides, wherein the porous body includes a plurality of holes. The imprint pattern structure is set in the first surface of the porous body, wherein the imprint pattern structure includes a plurality of convexes and a plurality of concaves between the convexes. A substrate is provided. A pressing step is performed to make a resist layer be pressed between the first surface of the porous body and a surface of the substrate and to fill the resist layer into the imprint pattern structure. A fluid in the resist layer and between the resist layer and the porous body is drawn out through the holes. The micro-nano imprint mould is removed.

According to a preferred embodiment of the present invention, the imprinting process further includes forming the resist layer to cover the surface of the substrate between the step of providing the substrate and the pressing step, and the fluid is drawn out during the pressing step.

According to a preferred embodiment of the present invention, the step of providing the micro-nano imprint mould includes performing a surface modification treatment on the first surface of the porous body to make the convexes and the concaves have different chemical properties.

### BRIEF DESCRIPTION OF THE DRAWINGS

The foregoing aspects and many of the attendant advantages of this invention are more readily appreciated as the same become better understood by reference to the following detailed description, when taken in conjunction with the accompanying drawings, wherein:

FIG. 1 illustrates a cross-sectional view of a micro-nano imprint mould in accordance with a preferred embodiment of the present invention;

FIG. 2A through FIG. 2D are schematic flow diagrams showing an imprinting process in accordance with a first preferred embodiment of the present invention;

FIG. 3A through FIG. 3E are schematic flow diagrams showing an imprinting process in accordance with a second preferred embodiment of the present invention; and

FIG. 4A through FIG. 4E are schematic flow diagrams showing an imprinting process in accordance with a third preferred embodiment of the present invention.

### DETAILED DESCRIPTION OF THE PREFERRED EMBODIMENT

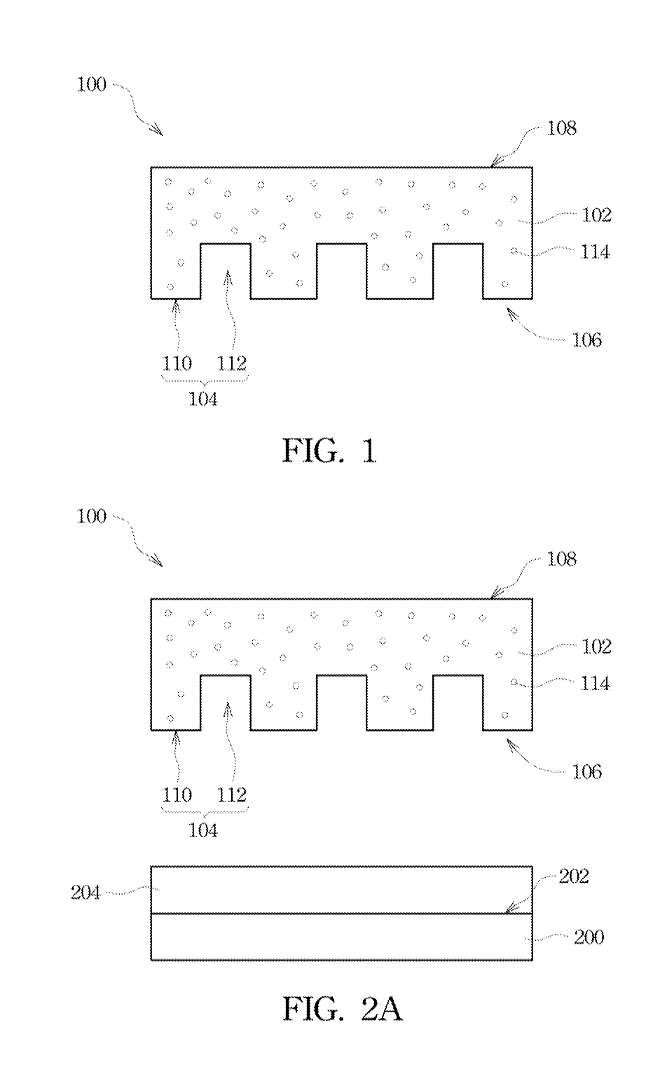

The present invention discloses a micro-nano imprint mould and an imprinting process. In order to make the illustration of the present invention more explicit, the following description is stated with reference to FIG. 1 through FIG. 4E.

Refer to FIG. 1. FIG. 1 illustrates a cross-sectional view of a micro-nano imprint mould in accordance with a preferred embodiment of the present invention. In one exemplary embodiment, a micro-nano imprint mould 100 mainly includes a porous body 102 and an imprint pattern structure 104 set on the porous body 102. The porous body 102 includes surfaces 106 and 108 on opposite sides, wherein the imprint pattern structure 104 is set in the surface 106 of the porous body 102. In the present embodiment, the imprint pattern structure 104 includes a plurality of convexes 110 and a plurality of concaves 112, wherein the concaves 112 are disposed between the convexes 110. In one embodiment, the imprint pattern structure 104 is a micrometer level pattern structure, and the range of the length, width or height of each of the convexes 110 and the concaves 112 may be between substantially 0.1 μg in and substantially 1000 μm. In another embodiment, the imprint pattern structure 104 is a nanometer level pattern structure, and the range of the length, width or height of each of the convexes 110 and the concaves 112 may be between substantially 1 nm and substantially 100 nm.

The porous body 102 is composed a porous material, so that the porous body 102 includes many holes 114, wherein the fluid including liquid and gas can flow between the surfaces 106 and 108 of the porous body 102 through the holes 114. When the fluid is a gas, the gas may be a reactive gas or an inert gas, wherein the reactive gas is, for example, air, nitrogen or oxygen, and the inert gas is, for example, argon or helium. The fluid may be the vapor of the solvent of the imprint resist, such as the vapor of the organic molecules and the inorganic molecules. When the fluid is liquid, the composition of the liquid may be a polymer solvent or monomers that can be polymerized to form a polymer, wherein the liquid may be water, alcohol, alkane, ether, ketone, ester, an organic liquid, an inorganic liquid, or a mixed liquid composed two or more of the aforementioned compositions.

In some embodiments, at least a part of the holes 114 penetrate between the convexes 110 of the porous body 102 and the surface 108, and the concaves 112 and the surface 108, so that the fluid can flow between the surface 108 and the convexes 110 and the concaves 112 on the surface 106 of the porous body 102 through the holes 114. In other embodiments, a surface modification treatment may be selectively performed on the convexes 110 of the porous body 102 to seal the holes 114 in the convexes 110. As a result, at least a part of the holes 114 penetrate between the concaves 112 and the surface 108, but no hole 114 penetrates between the convexes 110 and the surface 108, so that the fluid, which flows in the porous body 102 through the holes 114, only flows between the surface 108 of the porous body 102 and the concaves 112, and cannot flow between the surface 108 of the porous body 102 and the convexes 110.

When the porous body 102 is fabricated, the porosity and the mechanical property have to be considered. The material with high porosity has a lower airstream resistance but a poor mechanical property, so that the accuracy of the small size pattern is affected. Although the holes in the nanometer level do not affect the pattern, the airstream resistance is increased to block the fluid from flowing smoothly. In one preferred embodiment, an asymmetrical porous material may be used to enable the porous body 102 to include the advantages deriving from the high porosity material and the low porosity material. For example, in the manufacturing of the micro-nano imprint mould 100, a bulk including large holes and a large porosity is firstly used as a support, an inorganic or organic material including tiny holes is then grown on the bulk, and a pattern is formed on the small porosity material by an etching technique or an imprinting technique. The bulk including large holes must be tough and the mechanical property of the bulk must be strong enough, wherein the material of the bulk is, for example, a porous metal or a fine ceramics. The film material including tiny holes preferably has thinner thickness to prevent the airstream resistance from being affected, and the size of the porosity of the film material including tiny holes cannot be so small to affect the size of the pattern desired to be transferred, wherein the film material including tiny holes may be a ceramic film or a compound material including nanometer holes. A photolithography etching technique or an imprinting technique may be used to form the imprint pattern structure 104 on the porous body 102.

In one embodiment, the diameter sizes of all holes 114 of the porous body 102 are substantially the same. In other embodiments, the diameter sizes of all holes 114 of the porous body 102 may be different. For example, the diameter size of the holes 114 may be gradually increased from the surface 106 toward the surface 108 of the porous body 102. In addition, the distribution densities of the holes 114 in the porous body 102 may be the same or different, i.e. the distribution densities of the holes 114 in the porous body 102 may be gradually changing from the surface 106 toward the surface 108, such as the distribution densities of the holes 114 may be increased from the surface 106 toward the surface 108. In another embodiments, the porous body 102 may be composed of a plurality of porous material layers in a stack, wherein the porous material layers may include holes of different diameter sizes respectively, or the distribution densities of the holes of the porous material layers may be different. In one embodiment, the diameter range of the holes 114 may be between substantially 0.2 nm and substantially 500 μm.

In the present exemplary embodiment, the material of the porous body 102 may be an inorganic compound, an organic compound, or a composite composed of the inorganic compound and the organic compound, wherein the inorganic compound may be a metal or a ceramics, and the organic compound may be a thermosetting polymer or a thermoplastic polymer.

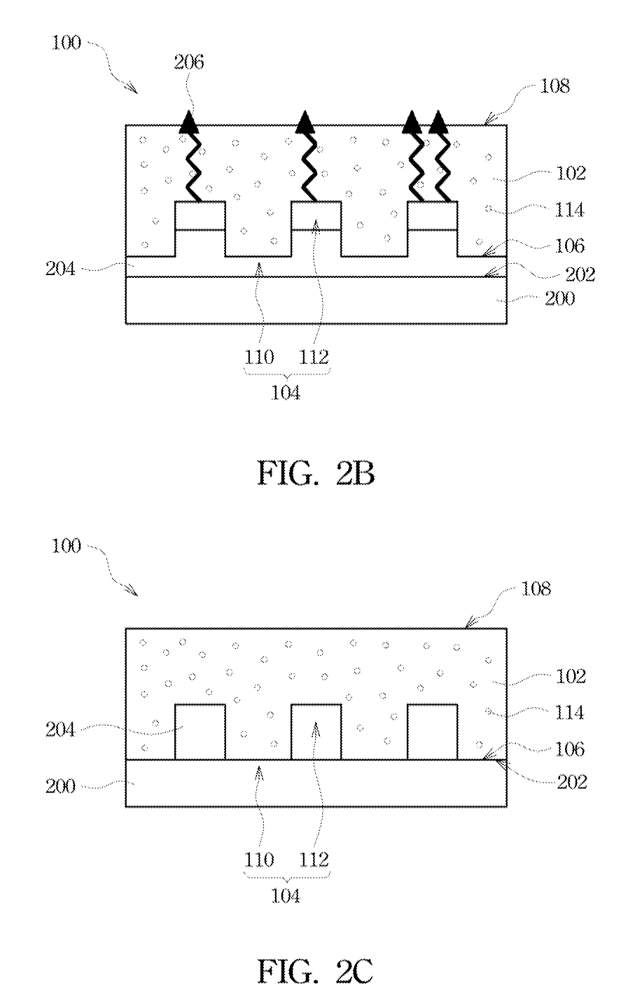

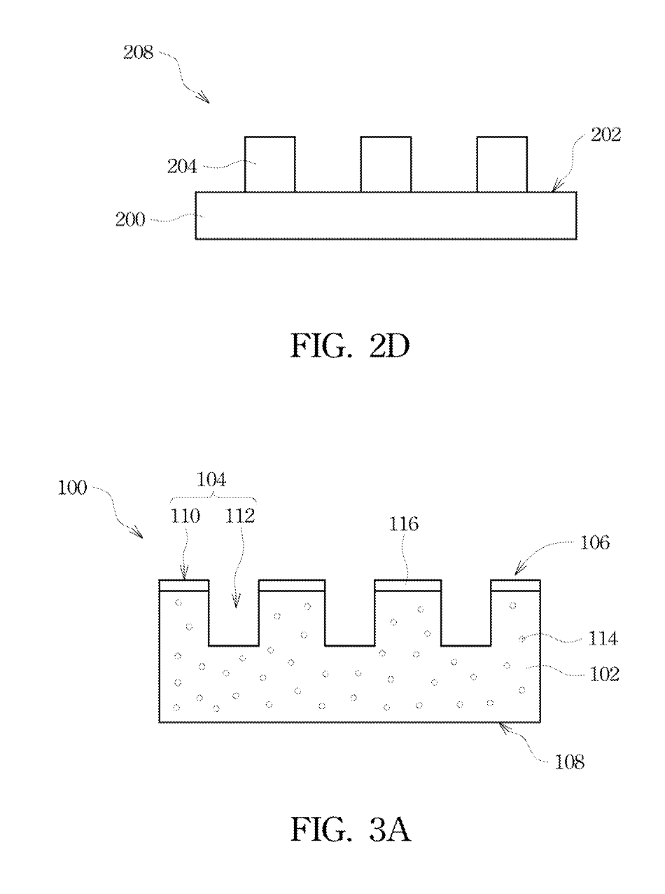

The micro-nano imprint mould 100 may be applied in an imprinting process, such as a hot-embossing process, a micro contact printing process, an UV-curing imprint process, a reversal imprinting process, a solvent-assisting imprinting process and a gel imprinting process, to perform a transferring step of a micro-nano pattern structure. Refer to FIGS. 2A through 2D. FIG. 2A through FIG. 2D are schematic flow diagrams showing an imprinting process in accordance with a first preferred embodiment of the present invention. In the present exemplary embodiment, a substrate 200 to be imprinted and an imprint mould, such as the aforementioned micro-nano imprint mould 100, are firstly provided. A surface 202 of the substrate 200 is coated with a resist layer 204, wherein the resist layer 204 may or may not include a solvent. The material of the substrate 200 may be an inorganic compound, an organic compound, or a composite composed of the inorganic compound and the organic compound. The inorganic compound may be glass, a silicon wafer, polysilicon, metal or ceramics, and the organic compound may be a thermosetting polymer or a thermoplastic polymer. The material of the resist layer 204 may be an inorganic compound, an organic compound, or a composite composed of the inorganic compound and the organic compound. The resist layer 204 is usually liquid and includes a solvent, wherein the solvent of the resist layer 204 may be water, an organic liquid, an inorganic liquid or a mixed liquid of the aforementioned liquids, and the organic liquid may be alcohol, alkane, ether, ketone or ester. Then, the surface 106 of the micro-nano imprint mould 100 faces the resist layer 204 on the surface 202 of the substrate 200, such as shown in FIG. 2A.

Then, a pressing step is performed to make the resist layer 204 be pressed between the surface 106 of the porous body 102 and the surface 202 of the substrate 200, to press the imprint pattern structure 104 of the micro-nano imprint mould 100 into the resist layer 204 and to fill the resist layer 204 into the imprint pattern structure 104 of the micro-nano imprint mould 100. In the present exemplary embodiment, during the pressing step, the solvent of the resist layer 204, the solvent vapor, and/or a gas fluid 206 remaining between the resist layer 204 and the surface 106 of the porous body 102 are drawn out through the holes 114 of the porous body 102, such as shown in FIG. 2B. The gas remaining between the resist layer 204 and the surface 106 of the porous body 102 may be a reactive gas, an inert gas or a mixture of a reactive gas and an inert gas, wherein the reactive gas may be air, nitrogen or oxygen, and the inert gas may be argon or helium.

In the present exemplary embodiment, the pressing step is performed to completely fill the concaves 112 of the imprint pattern structure 104 with the resist layer 204, to make the resist layer 204 only be in the concaves 112 and to make the convexes 110 directly contact with the surface 202 Of the substrate 200, such as shown in FIG. 2C.

Then, such as shown in FIG. 2D, the micro-nano imprint mould 100 may be directly removed to form an imprint pattern 208 composed of the resist layer 204 on the surface 202 of the substrate 200 to complete the imprinting process. In some embodiments, before the micro-nano imprint mould 100 is removed, a solidification treatment may be selectively performed on the resist layer 204 by, for example a heating method, an UV illumination method or a solvent-evaporating method, and the micro-nano imprint mould 100 is then removed.

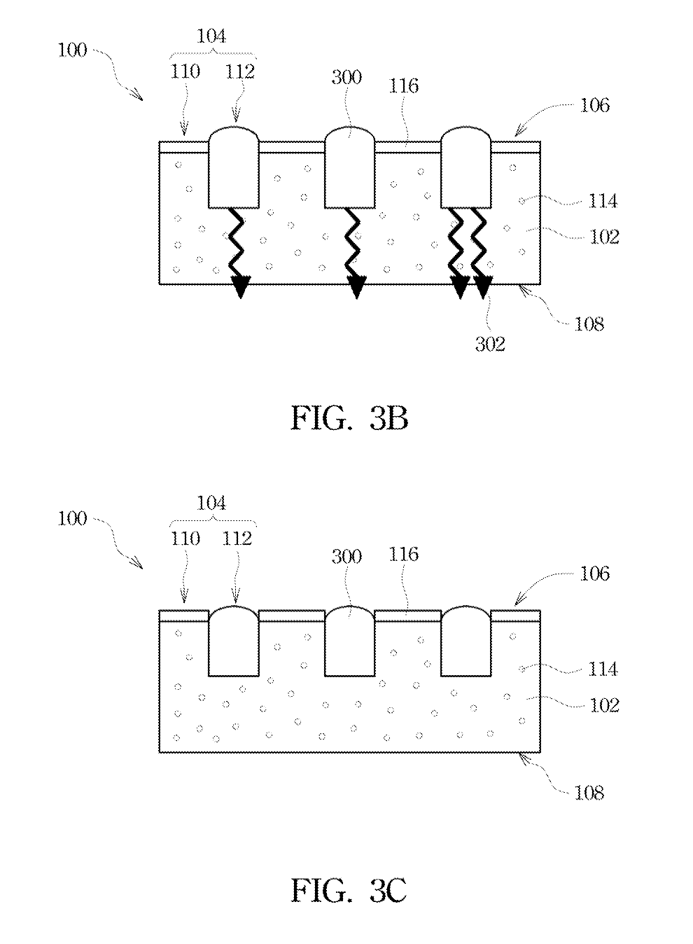

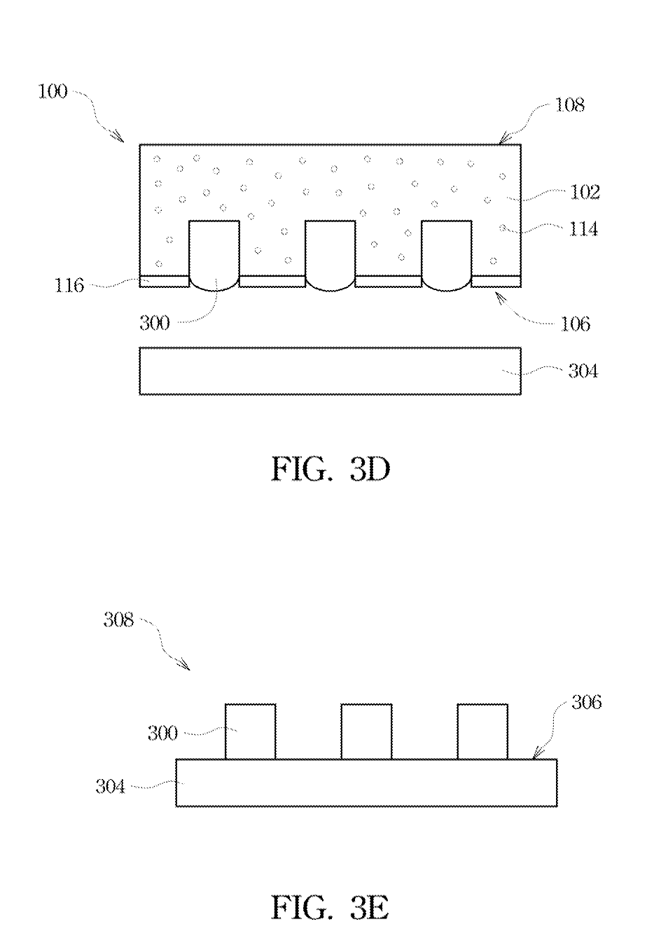

Refer to FIGS. 3A through 3E. FIGS. 3A through 3E are schematic flow diagrams showing an imprinting process in accordance with a second preferred embodiment of the present invention. In the present exemplary embodiment, an imprint mould, such as the aforementioned micro-nano imprint mould 100, is firstly provided. Then, a surface modification treatment is performed on surface 106 of the porous body 102 to make the surfaces of the convexes 110 and the concaves 112 of the imprint pattern structure 104 have different chemical properties. For example, the surface modification treatment enables the convexes 110 to have a hydrophobic property and the concaves 112 to have a hydrophile property; or enables the convexes 110 to have a solvent-hydrophobic property and the concaves 112 to have a solvent-hydrophile property. In some embodiments, the surface modification treatment of the surface 106 of the porous body 102 may be an inorganic solution surface treatment step, an organic solution surface treatment step, a surfactant solution surface treatment step or a plasma surface treatment step. The inorganic solution surface treatment step may use an acidic solution or an alkaline solution, the organic solution surface treatment step may use an alcohol solution, an alkane solution, an ether solution, a ketone solution, an ester solution, an acidic solution, an alkaline solution or a silane solution, the surfactant solution surface treatment step may use self-assembled monolayers or a surface active agent, and the plasma surface treatment step may use an activation technique or a graft technique. Such as shown in FIG. 3A, in the present exemplary embodiment, the surface modification treatment of the surface 106 of the porous body 102 is performed to form a surface modification layer 116, such as a hydrophobic layer, on the convexes 110 of the imprint pattern structure 104.

Then, a resist layer 300 is formed to cover the imprint pattern structure 104 of the surface 106 of the porous body 102. The surface 106 of the porous body 102 is treated by surface modification, so that the resist layer 300 only fills in the concaves 112 of the imprint pattern structure 104 and does not remain on the convexes 110 of the imprint pattern structure 104, such as shown in FIG. 3B. The material of the resist layer 300 may be an inorganic compound, an organic compound, or a composite composed of the inorganic compound and the organic compound. The resist layer 300 is usually liquid and includes a solvent, wherein the solvent of the resist layer 300 may be water, an organic liquid, an inorganic liquid or a mixed liquid of the aforementioned liquids, and the organic liquid may be alcohol, alkane, ether, ketone or ester. Such as shown in FIG. 3B, after the resist layer 300 is filled into the concaves 112 of the imprint pattern structure 104, a fluid 302 including the solvent and/or the solvent vapor of the resist layer 300 are drawn out through the holes 114 of the porous body 102. After the solvent and/or the solvent vapor of the resist layer 300 are drawn out, the size of the resist layer 300 is slightly decreased, such as shown in FIG. 3C.

Next, a substrate 304 is provided, and the surface 106 of the micro-nano imprint mould 100 faces a surface 306 of the substrate 304, such as shown in FIG. 3D. The material of the substrate 304 may be an inorganic compound, an organic compound, or a composite composed of the inorganic compound and the organic compound. The inorganic compound may be glass, a silicon wafer, polysilicon, metal or ceramics, and the organic compound may be a thermosetting polymer or a thermoplastic polymer. Subsequently, the surface 106 of the micro-nano imprint mould 100 is oppositely pressed to the surface 306 of the substrate 304 to make the resist layer 300 be pressed between the surface 106 of the porous body 102 and the surface 306 of the substrate 304. In the pressing step, the resist layer 300 in the concaves 112 of the imprint pattern structure 104 directly contacts with the surface 306 of the substrate 304. In addition, the resist layer 300 does not remain on the convexes 110 before imprinting, so that the surface modification layer 116 on the convexes 110 directly contacts with the surface 306 of the substrate 304.

In some embodiments, the resist material can flow into the concaves 112 of the imprint pattern structure 104 from the surface 108 of the porous body 102 through the holes 114 of the micro-nano imprint mould 100 after the convexes 110 of the micro-nano imprint mould 100 is oppositely connected to the surface 306 of the substrate 304. In other embodiments, a surface modification treatment may be firstly performed on the convexes 110 of the porous body 102 to seal the holes 114 on the convexes 110, the convexes 110 of the micro-nano imprint mould 100 is oppositely connected to the surface 306 of the substrate 304, and then the resist material flow into the concaves 112 of the imprint pattern structure 104 from the surface 108 of the porous body 102. The holes 114 on the convexes 110 are sealed, so that the resist material cannot flow out to stay between the convexes 110 of the micro-nano imprint mould 100 and the surface 306 of the substrate 304.

Subsequently, such as shown in FIG. 3E, the micro-nano imprint mould 100 may be directly removed to form an imprint pattern 308 composed of the resist layer 300 on the surface 306 of the substrate 304 to complete the imprinting process. In some embodiments, before the micro-nano imprint mould 100 is removed, a solidification treatment may be selectively performed on the resist layer 300 by, for example a heating method, an UV illumination method or a solvent-evaporating method, and the micro-nano imprint mould 100 is then removed.

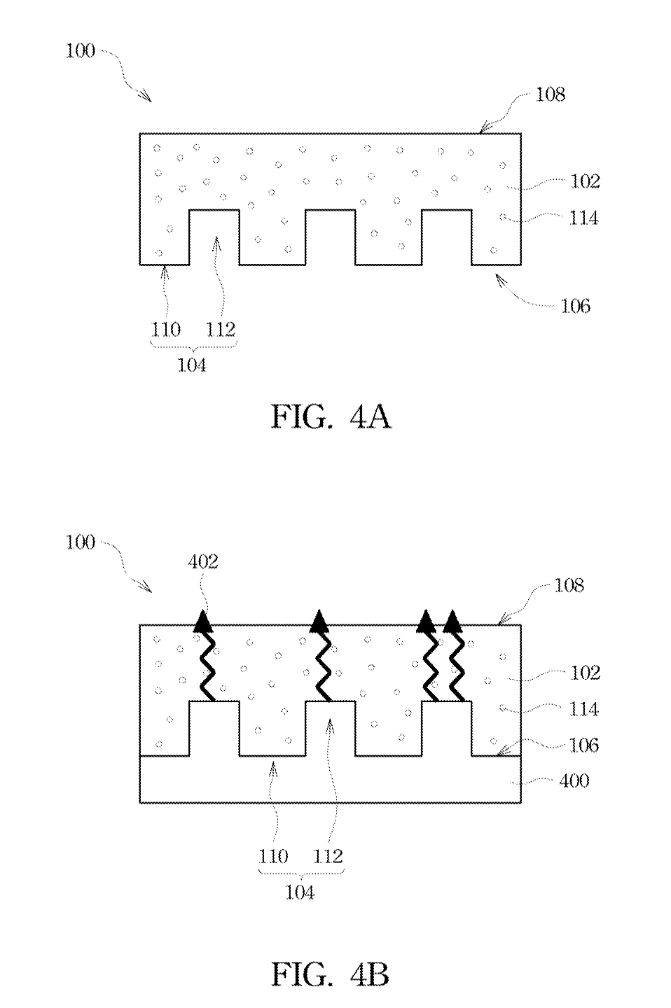

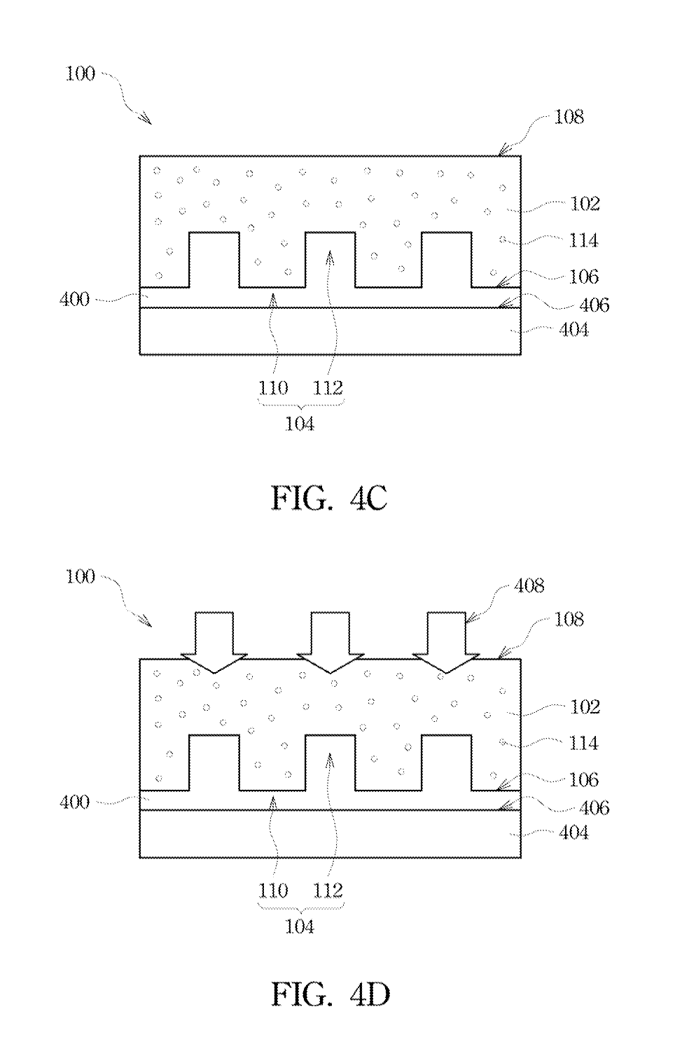

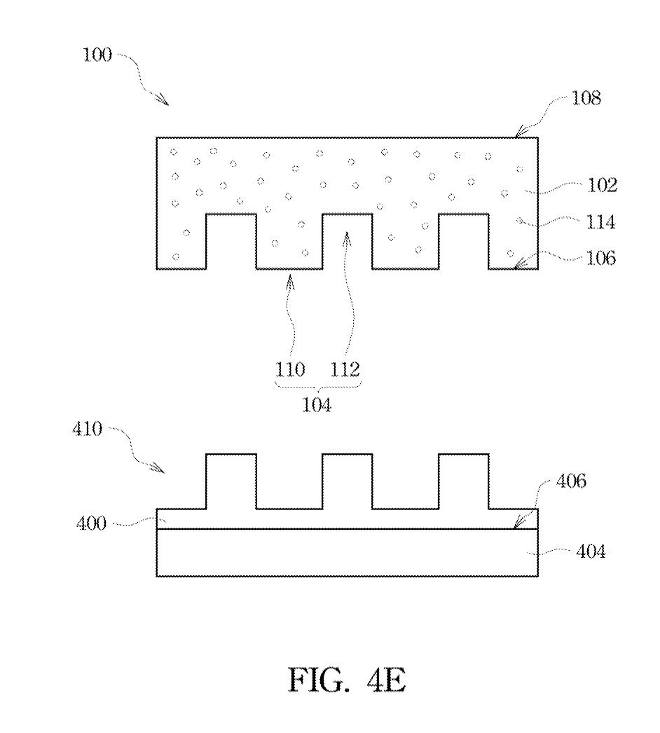

Refer to FIG. 4A through FIG. 4E. FIG. 4A through FIG. 4E are schematic flow diagrams showing an imprinting process in accordance with a third preferred embodiment of the present invention. In the present exemplary embodiment, an imprint mould, such as the aforementioned micro-nano imprint mould 100, is firstly provided. Then, such as shown in FIG. 4B, a resist layer 400 is formed to cover the imprint pattern structure 104 of the surface 106 of the porous body 102 by, for example, a spin coating method. The material of the resist layer 400 may be an inorganic compound, an organic compound, or a composite composed of the inorganic compound and the organic compound. The resist layer 400 is usually liquid and includes a solvent, wherein the solvent of the resist layer 400 may be water, an organic liquid, an inorganic liquid or a mixed liquid of the aforementioned liquids, and the organic liquid may be alcohol, alkane, ether, ketone or ester. Such as shown in FIG. 4B, after the resist layer 400 covers the imprint pattern structure 104, a fluid 402 including the solvent and/or the solvent vapor of the resist layer 400 are drawn out through the holes 114 of the porous body 102. After the solvent and/or the solvent vapor of the resist layer 400 are drawn out, the size of the resist layer 400 is slightly decreased, such as shown in FIG. 4C.

Then, a substrate 404 is provided, wherein the material of the substrate 404 may be an inorganic compound, an organic compound, or a composite composed of the inorganic compound and the organic compound. The inorganic compound may be glass, a silicon wafer, polysilicon, metal or ceramics, and the organic compound may be a thermosetting polymer or a thermoplastic polymer. Subsequently, the surface 106 of the micro-nano imprint mould 100 faces a surface 406 of the substrate 404, the surface 106 of the micro-nano imprint mould 100 is oppositely pressed to the surface 406 of the substrate 404 to make the resist layer 400 be pressed between the surface 106 of the porous body 102 and the surface 406 of the substrate 404, such as shown in FIG. 4C.

Subsequently, the micro-nano imprint mould 100 may be directly removed; or, a solidification treatment may be selectively performed on the resist layer 400 by, for example a heating method, an UV illumination method or a solvent-evaporating method, and the micro-nano imprint mould 100 is then removed. Such as shown IN FIG. 4D, in the removing of the micro-nano imprint mould 100, a high-pressure fluid 408 may be applied from the surface 108 of the porous body 102 toward the surface 106 through the holes 114 of the micro-nano imprint mould 100 to extract the resist layer 400 from the concaves 112 of the imprint pattern structure 104 to separate the micro-nano imprint mould 100 and the resist layer 400. The high-pressure fluid 408 may be a high-pressure gas or a high-pressure liquid. After the micro-nano imprint mould 100 is removed, such as shown in FIG. 4E, an imprint pattern 408 composed of the resist layer 400 is formed on the surface 406 of the substrate 404 to complete the imprinting process.

According to the aforementioned embodiments, one advantage of the present invention is that a porous body of a micro-nano imprint mould of the present invention is gas permeable, so that the fluidness of an imprint resist in imprinting is enhanced. Furthermore, the solvent in a resist solution, the solvent vapor and the air between the resist and the imprint mould can be drawn out through holes of the mould by vacuum air extracting during imprinting, so that the resist can completely fill up a pattern structure of the mould. Therefore, the imprint pattern of the mould can be accurately transferred to increase the accuracy and the yield of the imprinted pattern.

According to the aforementioned embodiments, another advantage of the present invention is that an imprint mould in an imprinting process of the present invention is composed of a porous material, so that a high-pressure fluid can be infused from a rear surface of the imprint mould to make the solidified resist layer be easily separated from the imprint mould. Therefore, the accuracy and the yield of the imprinting process can be enhanced, and the imprint speed can be increased.

According to the aforementioned embodiments, still another advantage of the present invention is that a solvent of an imprint resist and the evaporation thereof in an imprinting process of the present invention can penetrate a porous mould body through holes of the porous mould body, so that the shrink problem of the volume of the resist resulting from the evaporation of the solvent of the resist can be prevented to increase the faithfulness of the transfer of the pattern.

As is understood by a person skilled in the art, the foregoing preferred embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A micro-nano imprint mould, including:
a porous body including a first surface and a second surface on opposite sides, wherein the porous body includes a plurality of holes, and a fluid can flow between the first surface and the second surface through the holes; and
an imprint pattern structure set in the first surface of the porous body, wherein the imprint pattern structure includes a plurality of convexes and a plurality of concaves between the convexes.

2. The micro-nano imprint mould according to claim 1, wherein a diameter each of the holes is between substantially 0.2 nm and substantially 500 μm.

3. The micro-nano imprint mould according to claim 1, wherein diameter sizes of the holes are substantially the same.

4. The micro-nano imprint mould according to claim 3, wherein distribution densities of the holes in the porous body are the same.

5. The micro-nano imprint mould according to claim 3, wherein distribution densities of the holes in the porous body are gradually changing from the first surface toward the second surface.

6. The micro-nano imprint mould according to claim 1, wherein diameter sizes of the holes are gradually increased from the first surface toward the second surface.

7. The micro-nano imprint mould according to claim 1, wherein the porous body is composed of a plurality of porous material layers in a stack.

8. The micro-nano imprint mould according to claim 7, wherein the porous material layers include holes of different diameter sizes respectively.

9. The micro-nano imprint mould according to claim 7, wherein distribution densities of holes of the porous material layers are different.

10. The micro-nano imprint mould according to claim 1, wherein a material of the porous body is an inorganic compound, an organic compound, or a composite composed of the inorganic compound and the organic compound.

11. The micro-nano imprint mould according to claim 10, wherein the inorganic compound is a metal or a ceramics.

12. The micro-nano imprint mould according to claim 10, wherein the organic compound is a thermosetting polymer or a thermoplastic polymer.

13. The micro-nano imprint mould according to claim 1, wherein the fluid is a gas, and the gas is a reactive gas or an inert gas.

14. The micro-nano imprint mould according to claim 13, wherein the reactive gas is selected from a group consisting of air, nitrogen and oxygen.

15. The micro-nano imprint mould according to claim 13, wherein the inert gas is selected from a group consisting of argon and helium.

16. The micro-nano imprint mould according to claim 1, wherein the fluid is a vapor of organic molecules and inorganic molecules.

17. The micro-nano imprint mould according to claim 1, wherein the fluid is a liquid.

18. The micro-nano imprint mould according to claim 17, wherein the liquid is composed of a polymer solvent or monomers that can be polymerized to form a polymer.

19. The micro-nano imprint mould according to claim 17, wherein the liquid is water, alcohol, alkane, ether, ketone, ester, an organic liquid, an inorganic liquid, or a mixed liquid composed two or more of the aforementioned compositions.

20. The micro-nano imprint mould according to claim 1, wherein a range of a length, a width or a height of each of the convexes and the concaves is between substantially 0.1 μm and substantially 1000 μm.

21. The micro-nano imprint mould according to claim 1, wherein a range of a length, a width or a height of each of the convexes and the concaves is between substantially 1 nm and substantially 100 nm.

22. The micro-nano imprint mould according to claim 1, wherein at least a part of the holes penetrate between the convexes and the second surface, and the concaves and the second surface, so that the fluid can flow between the second surface and the convexes and the concaves through the holes.

23. The micro-nano imprint mould according to claim 1, wherein at least a part of the holes penetrate between the concaves and the second surface, and all of the holes do not penetrate between the convexes and the second surface, so that the fluid only flows between the second surface and the concaves.

24. An imprinting process, including:
providing a micro-nano imprint mould, wherein the micro-nano imprint mould includes:
a porous body including a first surface and a second surface on opposite sides, wherein the porous body includes a plurality of holes; and
an imprint pattern structure set in the first surface of the porous body, wherein the imprint pattern structure includes a plurality of convexes and a plurality of concaves between the convexes;
providing a substrate;
performing a pressing step to make a resist layer be pressed between the first surface of the porous body and a surface of the substrate and to fill the resist layer into the imprint pattern structure, wherein a fluid in the resist layer and between the resist layer and the porous body is drawn out through the holes; and
removing the micro-nano imprint mould.

25. The imprinting process according to claim 24, wherein a diameter of each of the holes is between substantially 0.2 nm and substantially 500 μm.

26. The imprinting process according to claim 24, wherein diameter sizes of the holes are substantially the same.

27. The imprinting process according to claim 26, wherein distribution densities of the holes in the porous body are the same.

28. The imprinting process according to claim 26, wherein distribution densities of the holes in the porous body are gradually changing from the first surface toward the second surface.

29. The imprinting process according to claim 24, wherein diameter sizes of the holes are gradually increased from the first surface toward the second surface.

30. The imprinting process according to claim 24, wherein the porous body is composed of a plurality of porous material layers in a stack.

31. The imprinting process according to claim 30, wherein the porous material layers include holes of different diameter sizes respectively.

32. The imprinting process according to claim 30, wherein distribution densities of holes of the porous material layers are different.

33. The imprinting process according to claim 24, between the step of providing the substrate and the pressing step, further including forming the resist layer to cover the surface of the substrate.

34. The imprinting process according to claim 33, wherein the fluid is drawn out during the pressing step.

35. The imprinting process according to claim 33, wherein the convexes directly contacts with the surface of the substrate.

36. The imprinting process according to claim 24, between the step of providing the micro-nano imprint mould and the pressing step, further including forming the resist layer to cover the imprint pattern structure.

37. The imprinting process according to claim 36, wherein the fluid is drawn out before the pressing step.

38. The imprinting process according to claim 24, wherein the step of providing the micro-nano imprint mould includes performing a surface modification treatment on the first surface of the porous body to make the convexes and the concaves have different chemical properties.

39. The imprinting process according to claim 38, wherein the surface modification treatment is performed to enable the convexes to have a hydrophobic property and the concaves to have a hydrophile property.

40. The imprinting process according to claim 38, wherein the surface modification treatment is performed to enable the convexes to have a solvent-hydrophobic property and the concaves to have a solvent-hydrophile property.

41. The imprinting process according to claim 38, wherein the surface modification treatment is an inorganic solution surface treatment step, an organic solution surface treatment step, a surfactant solution surface treatment step or a plasma surface treatment step.

42. The imprinting process according to claim 41, wherein the inorganic solution surface treatment step uses an acidic solution or an alkaline solution.

43. The imprinting process according to claim 41, wherein the organic solution surface treatment step use an alcohol solution, an alkane solution, an ether solution, a ketone solution, an ester solution, an acidic solution, an alkaline solution or a silane solution.

44. The imprinting process according to claim 41, wherein the surfactant solution surface treatment step use self-assembled monolayers or a surface active agent.

45. The imprinting process according to claim 41, wherein the plasma surface treatment step use an activation technique or a graft technique.

46. The imprinting process according to claim 38, between the step of providing the micro-nano imprint mould and the pressing step, further including filling the resist layer only into the concaves.

47. The imprinting process according to claim 24, wherein the step of removing the micro-nano imprint mould further includes applying a high-pressure fluid from the second surface toward the first surface of the porous body through the holes.

48. The imprinting process according to claim 24, wherein the fluid includes a solvent and a solvent vapor of the resist layer and a gas between the resist layer and the porous body.

49. The imprinting process according to claim 48, wherein the solvent of the resist layer is water, an organic liquid, an inorganic liquid or a mixed liquid of the aforementioned liquids, and the organic liquid is alcohol, alkane, ether, ketone or ester.

50. The imprinting process according to claim 48, wherein the gas between the resist layer and the porous body is a reactive gas, an inert gas or a combination thereof, wherein the reactive gas is air, nitrogen or oxygen, and the inert gas is argon or helium.

51. The imprinting process according to claim 24, wherein a material of the resist layer is an inorganic compound, an organic compound, or a composite composed of the inorganic compound and the organic compound.

52. The imprinting process according to claim 24, wherein a material of the substrate is an inorganic compound, an organic compound, or a composite composed of the inorganic compound and the organic compound.

53. The imprinting process according to claim 52, wherein the inorganic compound is glass, a silicon wafer, polysilicon, metal or ceramics.

54. The imprinting process according to claim 52, wherein the organic compound is a thermosetting polymer or a thermoplastic polymer.

55. The imprinting process according to claim 24, wherein the pressing step includes:
connecting the convexes to the surface of the substrate oppositely; and
making a resist material flow into the concaves from the second surface of the porous body through the holes.

56. The imprinting process according to claim 55, between the step of providing the substrate and the pressing step, further including performing a surface modification treatment on the convexes of the porous body to seal the holes on the convexes.

57. The imprinting process according to claim 24, between the pressing step and the step of removing the micro-nano imprint mould, further including performing a solidification treatment on the resist layer.

58. The imprinting process according to claim 57, wherein the solidification treatment is performed by a heating method, an UV illumination method or a solvent-evaporating method.

59. The imprinting process according to claim 24, wherein the resist layer includes a solvent.

60. The imprinting process according to claim 24, wherein the resist layer does not include a solvent.
